(19) United States
(12) Patent Application Publication
(10) Pub. No.: US 2006/0061249 A1
(43) Pub. Date: Mar. 23, 2006

(54) Reflecting structure for planar gas discharge lamps

(76) Inventors: Tzu-Shou Kuo, Miao-Li County (TW); Bor-Jyh Pan, Miao-Li County (TW)

Correspondence Address: BIRCH STEWART KOLASCH & BIRCH, PO BOX 747, FALLS CHURCH, VA, 22040-0747, US

(21) Appl. No.: 10/946,003

(22) Filed: Sep. 22, 2004

(51) Int. Cl. H01J 5/16; H01K 1/26; H01J 17/49

(52) U.S. Cl. 313/113; 313/582; 313/110

(57) ABSTRACT

A reflecting structure for planar gas discharge lamps to improve luminance includes a front glass panel on a light emission side, a rear glass panel on a backlight side, at least one pair of electrodes, a fluorescent layer abutting the light emission side and a reaction gas held between the front glass panel and the rear glass panel. The electrodes have a voltage difference to activate the reaction gas to generate discharge which actuates the fluorescent layer to generate light. The light emits through the light emission side of the front glass panel. The invention further provides a light reflective element to reflect the light passing through the backlight side to the front light emission side to increase light utilization and improve the luminance of the light emission side.

### FIELD OF THE INVENTION

The present invention relates to a gas discharge lamp and particularly to a reflecting structure that has a light reflective element on a backlight side of a planar gas discharge lamp to reflect light passing through the backlight side to a front light emission side to increase the luminance of the planar gas discharge lamp.

### BACKGROUND OF THE INVENTION

In recent years developments of portable electronic products and communication related industries have thrived significantly. Application of liquid crystal display (LCD) also grows tremendously. In these products, thin and light are key requirements. Another important issue is low electric consumption. In LCD, the element that consumes most power is the light source. In general, a backlight unit (BLU) means an element to provide a light source on the back side of a product. It usually serves as the light source of a planar display device such as the LCD. The light emitting elements that are most commonly used now include Electro luminescence (EL), Cold Cathode Fluorescent Lamp (CCFL) and light emitting diode (LED). The light source is positioned on the lateral sides or the back side. How to increase the penetration of light (utilization) and reduce loss have significant impact to increasing of luminance or lowering of electric consumption. The solutions generally focus on improving the light penetration of the LCD panel and increasing the luminance of the light source. The former approach involves the technique of LCD panel fabrication process and material. The other approach focuses on improving light generation efficiency of the light source. One of the backlight light sources now being used is the planar gas discharge lamp as shown in FIG. 1. Its main operation principle is to activate a reaction gas (generally an inertial gas) to discharge and actuate a fluorescent material coated on a light emission side to emit light. The electric power required is provided by a backlight inverter 20. A reference technique may be found in R.O.C. patent publication No. 521300 entitled “Discharge lamp having a dielectric barrier interposed between the base board and the cover lid”.

Such a planar gas discharge lamp has two types depending on the design of electrodes, namely the external electrode type (referring to FIG. 2) and the internal electrode type (referring to FIG. 3). They generally include a upper layer glass 10 on the light emission side and a lower layer glass 11 on the backlight side to form a sealed chamber 12 therebetween. The chamber 12 is filled with a reaction gas. The upper layer glass 10 usually has a bracing section 101 to provide the required support. The chamber 12 has an inner surface abutting the light emission side coated with a fluorescent material 13. The lower layer glass 11 has an inner wall surface close to the backlight side coated with a reflective material 14 to reflect light projecting downward (i.e. projecting towards the backlight side). The external electrode type has the electrodes 15a and 15b attached to the outer surface of the lower layer glass 11, and covered by an insulating layer 16. The internal electrode type has the electrodes 15a and 15b located inside the chamber 12 (as shown in FIG. 3) and a bracing member 17 interposed between the upper layer glass 10 and the lower layer glass 11. The electrodes 15a and 15b receive electric current transformed by the backlight inverter 20 to activate the reaction gas in the chamber 12 to generate discharge and release ultra violet light to actuate the fluorescent material 13 to generate light.

Take the external electrode type planar gas discharge lamp as an example, in order to avoid affecting the discharge, the reflective material 14 must be very thin. As a result, a portion of light emitted from the fluorescent material 13 tends to pass through the backlight side. The insulating layer 16 covering the electrodes 15a and 15b does not reflect light. Thus a portion of light are lost through the backside of the planar gas discharge lamp, and light generating efficiency is affected. Moreover, the backside of the planar gas discharge lamp does not have cooling and heat dissipation design. Dispersing of heat generated by the planar gas discharge lamp is difficult.

### SUMMARY OF THE INVENTION

The primary object of the present invention is to provide a reflecting structure to increase light utilization and improve luminance of the light emission side of a planar gas discharge lamp.

The basic structure of the planar gas discharge lamp includes a front glass panel on a light emission side, a rear glass panel on a backlight side and a sealed hollow chamber located between the front glass panel and the back glass panel filled with a reaction gas. The inner surface of the front glass panel facing the chamber is coated with a layer of fluorescent material. At least a pair of electrodes are provided connecting to an inverter. The voltage difference between the electrodes activates the reaction gas to generate discharge which actuates the fluorescent layer to generate light that emits through the light emission side of the front glass panel. According to one embodiment of the invention, a reflective element is located on the backlight side to reflect the light passing through the backlight side to the front light emission side thereby to increase light utilization and improve luminance of the light emission side.

Another object of the invention is to provide a reflecting structure to enhance light utilization and facilitate heat dissipation of the planar gas discharge lamp.

To achieve the foregoing objects, the invention has a heat conductive base material and a composite reflective element made of reflective material attached to the backlight side to reflect the light passing through the backlight side to the front light emission side thereby to increase light utilization and improve heat dissipation.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional planar gas discharge lamp.

FIG. 2 is a sectional view of a conventional external electrode planar gas discharge lamp.

FIG. 3 is a sectional view of a conventional internal electrode planar gas discharge lamp.

FIG. 4 is a sectional view of a first embodiment of the invention showing the reflecting structure for an external electrode planar gas discharge lamp.

FIG. 5 is a sectional view of a second embodiment of the invention showing the reflecting structure for an external electrode planar gas discharge lamp.

FIG. 6 is a sectional view of a third embodiment of the invention showing the reflecting structure for an internal electrode planar gas discharge lamp.

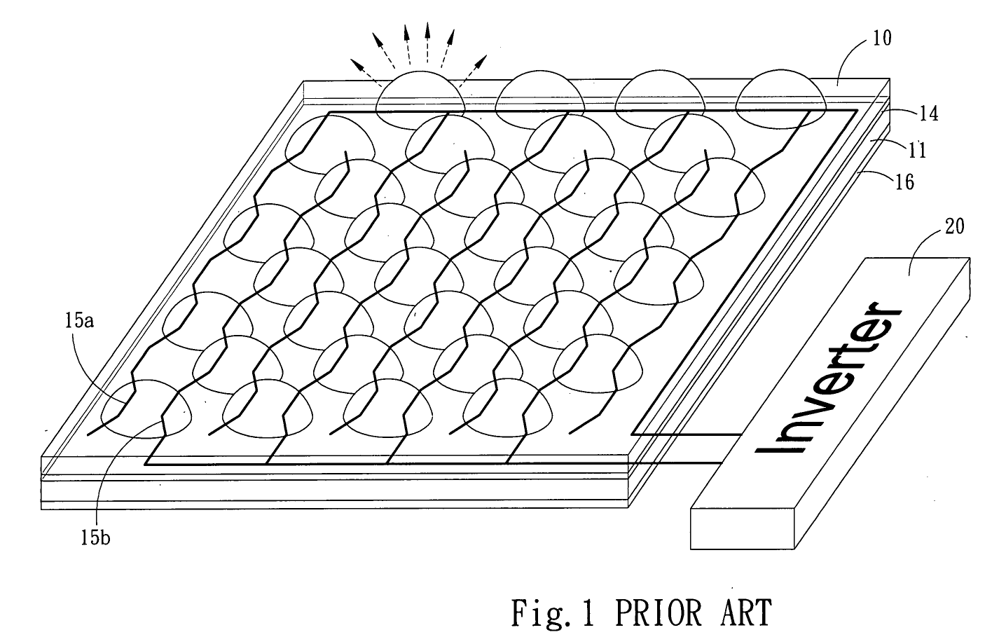

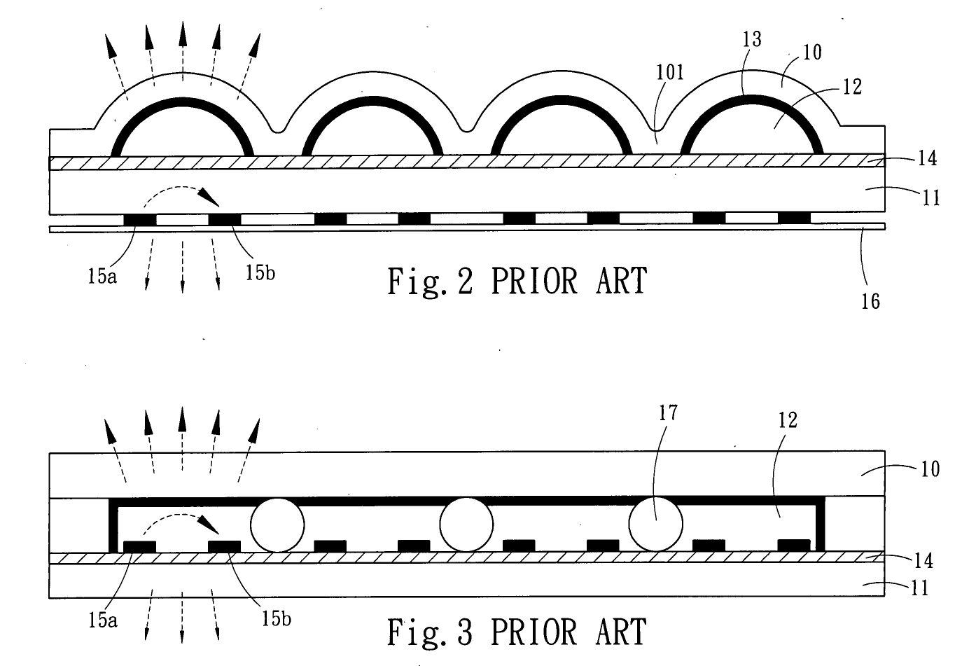

### DETAILED DESCRIPTION OF THE PREFERRED EMBODIMENTS

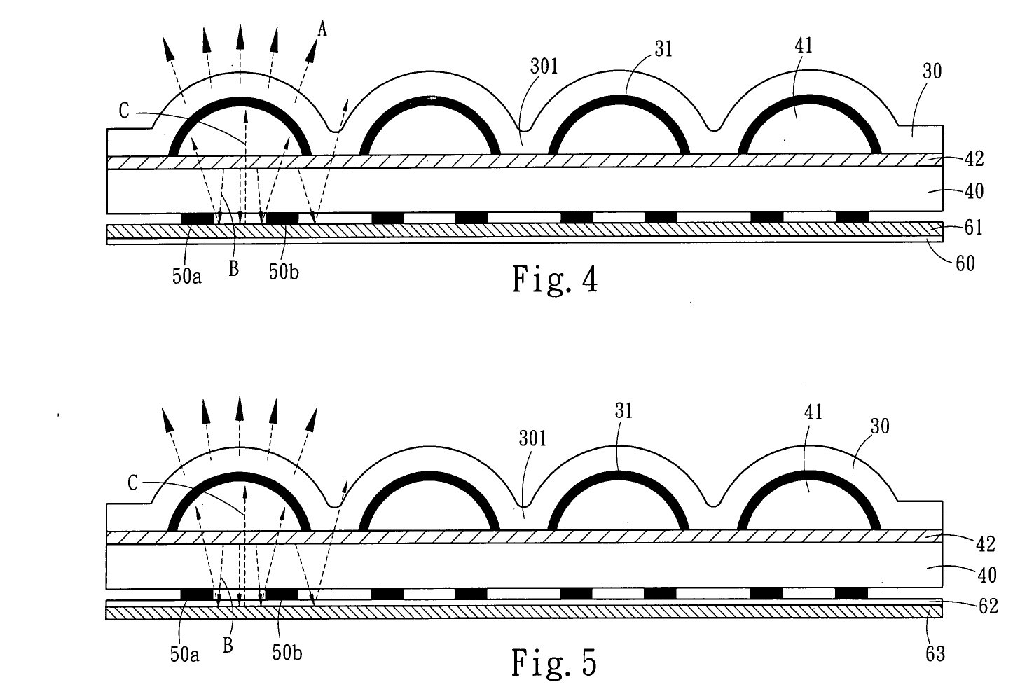

Please refer to FIG. 4 for a first embodiment of the present invention for a planar gas discharge lamp that adopts external electrodes. It includes:

a front glass panel 30 located on a light emission side of the planar gas discharge lamp. Light generated by the planar gas discharge lamp emits through the front glass panel 30;

a rear glass panel 40 located on a backlight side of the planar gas discharge lamp to form a sealed and hollow chamber 41 with the front glass panel 30. The chamber 41 is filled with a reaction gas which may be neon or a mixture of other gases (such as Xe, He and the like);

at least one pair of electrodes 50a and 50b connecting to an inverter (not shown in the drawing). The voltage difference of the electrodes 50a and 50b activates the reaction gas to generate discharge;

a fluorescent material 31 coated on the surface of an inner side of the front glass panel 30 facing the chamber 41 to be actuated by the discharge mentioned above and generate light. Most of the light emits through the light emission side of the front glass panel 30 (indicated by arrows A in the drawings); and

a light reflective material 42 coated on the surface of an inner side of the rear glass panel 40 facing the chamber 41 to reflect the light passing through the backlight side (indicated by arrows B in the drawings) to the front light emission side (indicated by arrows C in the drawings).

The first embodiment set forth above adopts external electrodes. Namely the electrodes 50a and 50b are located outside the chamber 41. The front glass panel 30 has bracing sections 301 to provide support. The cross section of the front glass panel 30 between two neighboring bracing sections 301 is formed in an arched or curved shape to evenly distribute the light. The electrodes 50a and 50b are preferably located between two neighboring bracing sections 301.

The reflecting structure of the invention includes a light reflective element on an outer side surface of the rear glass panel 40, namely on the back side of the electrodes 50a and 50b. FIG. 4 shows the first embodiment in which a base board 60 is provided. The base board 60 has one surface coated with a highly reflective film 61 which is preferably located between the base board 60 and the electrodes 50a and 50b to be protected by the base board 60.

Refer to FIG. 5 for another embodiment of the invention. The back side of the electrodes 50a and 50b (namely facing the backlight side) is covered by an insulating layer 62. Then a highly reflective film 63 is coated on the back side of the insulating layer 62 to form the reflective element.

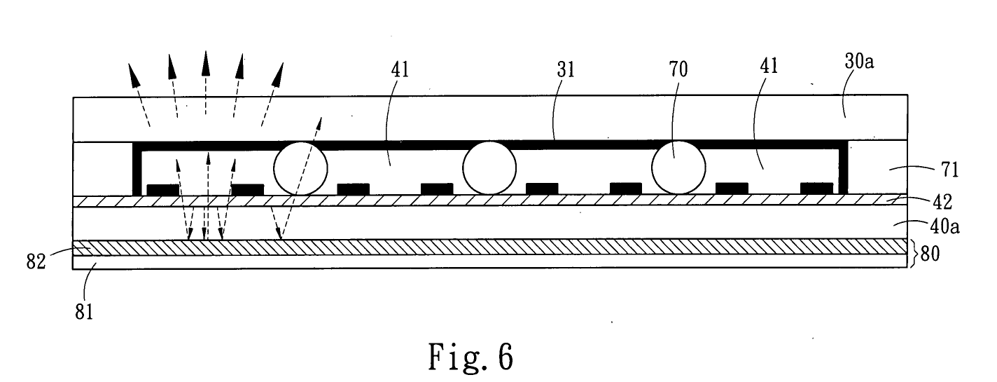

Refer to FIG. 6 for yet another embodiment of the invention. It adopts internal electrodes. Namely the electrodes 50a and 50b are located inside the chamber 41. The front glass panel 30a and the rear glass panel 40a are flat panels with bracing elements 70 interposed therebetween. A hollow and sealed chamber 41 also is formed and bordered by the front glass panel 30a, the rear glass panel 40a and the bracing elements 71, and filled with a reaction gas. The surface of an inner side of the front glass panel 30a facing the chamber 41 is coated with a fluorescent material 31, and the surface of an inner side of the rear glass panel 40a facing the chamber 41 is coated with a reflective material 42. The electrodes 50a and 50b are located on the surface of the reflective material 42 facing the fluorescent material 31 to actuate the reaction gas to generate discharge. The reflecting structure includes a composite reflective element 80 which consists of a thermal conductive base material 81 and a reflective material 82 attached to the backlight side of the rear glass panel 40a. Thus the light passing through the backlight side is reflected to the front light emission side to increase light utilization. It also provides heat dissipation effect.

In summary, the reflecting structure for planar gas discharge lamps of the invention can reflect light to the light emission side to increase the luminance of the light emission side. It also may be coupled with a thermal conductive material to improve heat dissipation effect. The reflecting structure thus formed can prevent light leakage even if the back panel of the backlight module has openings.

What is claimed is:

1. A reflecting structure for a planar gas discharge lamp comprising:
a front glass panel located on a light emission side of the planar gas discharge lamp;
a rear glass panel located on a backlight side of the planar gas discharge lamp to form a sealed and hollow chamber with the front glass panel, the chamber being filled with a reaction gas;
at least one pair of electrodes connecting to an inverter to produce a voltage difference to actuate the reaction gas to generate discharge;
a fluorescent material coated on a surface of an inner side of the front glass panel facing the chamber to be actuated by the discharge to generate light, a great portion of the light emitting through the light emission side of the front glass panel;
a light reflective material coated on a surface of an inner side of the rear glass panel facing the chamber to reflect the light passing through the backlight side of the planar gas discharge lamp to the front light emission side; and
a light reflective element located on an outer side of the backlight side of the planar gas discharge lamp to reflect the light passing through the backlight side to the front light emission side to increase light utilization and improve luminance of the light emission side of the planar gas discharge lamp.

2. The reflecting structure of claim 1, wherein the electrodes are located outside the chamber.

3. The reflecting structure of claim 1, wherein the light reflective element includes a base board and a reflective film coated on the surface of the base board.

4. The reflecting structure of claim 3, wherein the reflective film is located between the electrodes and the base board.

5. The reflecting structure of claim 2, wherein the light reflective element includes an insulating layer covering a backside of the electrodes and a reflective film coated on a back side of the insulating layer.

6. The reflecting structure of claim 5, wherein the insulating layer is located between the electrodes and the reflective film.

7. The reflecting structure of claim 1, wherein the electrodes are located in the chamber.

8. The reflecting structure of claim 1, wherein the light reflective element is a composite reflective element including a reflective material coated on the backlight side of the rear glass panel and a thermal conductive base material.

9. The reflecting structure of claim 8, wherein the reflective material is located between the thermal conductive base material and the electrodes.
